(19) United States
(12) Patent Application Publication
(10) Pub. No.: US 2026/0086876 A1
(43) Pub. Date: Mar. 26, 2026

(54) METHODS AND APPARATUSES FOR MOBILE NETWORK DISTRIBUTED COMPUTING

(71) Applicant: TELEFONAKTIEBOLAGET LM ERICSSON (PUBL), Stockholm (SE)

(72) Inventors: Guido Carlo Ferrante, Stockholm (SE); Giuseppe Caso, Stockholm (SE); Johan Eker, LUND (SE); Hugo Tullberg, NYKÖPING (SE)

(21) Appl. No.: 19/106,810

(22) PCT Filed: Aug. 26, 2022
(86) PCT No.: PCT/IB2022/058029

§ 371 Date: Feb. 26, 2025

(51) Int. Cl. G06F 9/50; G06F 9/48

(52) U.S. Cl. CPC G06F 9/5072; G06F 9/4881

(57) ABSTRACT

A method performed by a computing manager in a mobile network is disclosed. The method includes receiving, from a job seeker, a request to execute a job in the mobile network, determining an assignment of job portions to one or more job workers based on requirements of the job, information regarding resources that the plurality of job workers are willing to make available for job executions, information regarding a network condition of the mobile network, and information regarding network resources allocated to job workers, changing a network resource allocation for at least one of the one or more job workers, providing job portion assignments to the one or more job workers in accordance with the determined assignment, aggregating partial job execution results received from the one or more job workers to generate a full job execution result, and providing the full job execution result to the job seeker.

### TECHNICAL FIELD

Embodiments of the invention relate to the field of distributed computing; and more specifically, to distributed computing in a mobile network.

### BACKGROUND

Machine learning (ML) is a field of inquiry devoted to understanding and building methods that “learn” to improve performance on some set of tasks. It is seen as a form of artificial intelligence. ML algorithms build a model based on sample data, also known as training data, that can be used to make predictions or decisions without being explicitly programmed to do so. ML algorithms are used in a wide variety of tasks such as email filtering, speech recognition, and other tasks where it is difficult or unfeasible to develop conventional algorithms to perform the tasks.

ML algorithms typically require large amounts of computing resources and storage resources for execution. As such, ML algorithms are often executed in the cloud. Cloud computing is the on-demand delivery of information technology (IT) resources over the internet with pay-as-you-go pricing. Instead of buying, owning, and maintaining physical data centers and servers, users can access IT resources such as computing power, storage, and databases, on an as-needed basis from a cloud provider such as Amazon Web Services (AWS) by Amazon. Cloud computing requires that data, which may have been generated and collected by multiple different distributed devices (e.g., Internet of Things (IoT) devices), is accumulated in the cloud, which is typically distant from both the sources of the data and the final users of the built models. Thus, challenges exist in terms of the communication costs resulting from exchanging data and models with the cloud (e.g., network latency and congestion).

To address the above challenges, edge and fog computing paradigms have been proposed that aim at bringing IT resources closer to the final users to help reduce the communication overhead. Edge computing is a distributed computing paradigm that brings computing resources and storage resources closer to the sources of data. Edge computing may leverage computing resources and/or storage resources that are available closer to the edges of a communication network (e.g., closer to the end user devices (e.g., user equipment (UE)) of a mobile network).

Fog computing is a distributed computing paradigm that uses edge devices (e.g., the UEs of a mobile network) to carry out a substantial amount of computation. Fog computing may extend edge computing by exploiting the ever-increasing amount of computing and storage resources available in the end user devices themselves. Fog computing can be used to reduce the amount of data exchange with the cloud. For example, in ML, the use of a federated learning paradigm is becoming popular, as it makes it possible to train a model in a distributed fashion that avoids/reduces data exchange with the cloud. With this paradigm, end user devices perform computing tasks (also referred to as jobs) by exploiting local data they have generated and/or collected. Then, the local job results (instead of the data itself) are sent to a central server that agglomerates the local job results to derive a global job result (e.g., a ML model).

Compared to cloud computing, edge/fog computing typically requires more devices to be involved in job execution, with each device expected to have less resources compared to a dedicated cloud platform (e.g., a supercomputer). Moreover, the different devices involved in job execution are expected to have different computing/storage capabilities as well as heterogeneous and dynamic communication conditions (e.g., when mobile devices are involved in job execution).

Crowd computing is a computing paradigm that distributes a computing task among remote computing devices across a public network. Conventional over-the-top (OTT) crowd computing solutions distribute a computing task among computing devices under constraints that are set by those computing devices. For example, a crowd computing solution for cryptocurrency mining may take into account the amount of computing resources and the connection speed offered by each computing device when deciding how to distribute the computing task among the computing devices.

### SUMMARY

A method performed by one or more computing devices in a mobile network for executing a job in the mobile network is disclosed herein. The method includes receiving, from a job seeker, a request to execute the job in the mobile network, obtaining, for each of a plurality of job workers that are part of the mobile network, information regarding resources that the job worker is willing to make available for job executions, determining an assignment of job portions to one or more job workers of the plurality of job workers based on requirements of the job, the information regarding resources that the plurality of job workers are willing to make available for job executions, information regarding a network condition of the mobile network, and information regarding network resources allocated to job workers in the mobile network, changing a network resource allocation for at least one of the one or more job workers, providing job portion assignments to the one or more job workers in accordance with the determined assignment, receiving partial job execution results generated by the one or more job workers, aggregating the partial job execution results to generate a full job execution result, and providing the full job execution result to the job seeker.

A non-transitory machine-readable storage medium is disclosed herein that provides instructions that, if executed by one or more processors of one or more computing devices in a mobile network, causes the one or more computing devices to carry out operations for executing a job in the mobile network. The operations include receiving, from a job seeker, a request to execute a job in the mobile network, obtaining, for each of a plurality of job workers that are part of the mobile network, information regarding resources that the job worker is willing to make available for job executions, determining an assignment of job portions to one or more job workers of the plurality of job workers based on requirements of the job, the information regarding resources that the plurality of job workers are willing to make available for job executions, information regarding a network condition of the mobile network, and information regarding network resources allocated to job workers in the mobile network, changing a network resource allocation for at least one of the one or more job workers, providing job portion assignments to the one or more job workers in accordance with the determined assignment, receiving partial job execution results generated by the one or more job workers, aggregating the partial job execution results to generate a full job execution result, and providing the full job execution result to the job seeker.

### BRIEF DESCRIPTION OF THE DRAWINGS

The invention may best be understood by referring to the following description and accompanying drawings that are used to illustrate embodiments of the invention. In the drawings:

FIG. 1 is a diagram of an environment in which jobs can be executed in a communication network, according to some embodiments.

FIG. 2 is a diagram of a mobile network environment in which jobs can be executed, where the job seeker is part of the mobile network, according to some embodiments.

FIG. 3 is a diagram of a mobile network environment in which jobs can be executed, where the job seeker is external to the mobile network and where both mobile devices and non-mobile devices in the mobile network participate in job execution, according to some embodiments.

FIG. 4 is a flow diagram of a method for executing a job in a communication network, according to some embodiments.

FIG. 5 is a flow diagram of a method performed by one or more computing devices implementing a computing manager for executing a job in a mobile network, according to some embodiments.

FIG. 6 shows an example of a communication system in accordance with some embodiments.

FIG. 7 shows a user equipment (UE), according to some embodiments.

FIG. 8 shows a network node, according to some embodiments.

FIG. 9 is a diagram of a host, according to some embodiments.

FIG. 10 is a diagram showing a virtualization environment in which functions implemented by some embodiments may be virtualized.

### DETAILED DESCRIPTION

The following description describes methods and apparatus for executing jobs in a communication network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, conventional over-the-top (OTT) crowd computing solutions distribute a computing task among computing devices under constraints that are set by those computing devices. For example, a crowd computing solution for cryptocurrency mining may take into account the amount of computing resources and the connection speed offered by each computing device when deciding how to distribute the computing task among the computing devices. However, conventional crowd computing solutions do not have access to detailed information regarding computing devices or the underlying communication network and do not have the ability to affect the connection speed available to computing devices.

Embodiments disclosed herein are based on a recognition that a communication network (e.g., a mobile network such as a Fifth Generation (5G) mobile network managed by a mobile network operator (MNO)) can function as the substrate on which a distributed computing platform with enormous, often unused, computing/storage resources, can be instantiated. A communication network typically has a large amount of unused computational power (e.g., in the end user devices of the communication network and/or in the infrastructure of the communication network).

A framework is disclosed herein that allows a network operator to leverage the vast amount of unused computational power available in its communication network (e.g., in the end user devices and/or other devices that implement the infrastructure of the communication network) to execute jobs. In an embodiment, the framework includes three roles: job seeker, job workers, and a computing manager. The job seeker is a network entity that submits requests for jobs to be executed in the communication network. The job seeker may be a network entity that is part of the communication network or external to the communication network. The job workers are network entities that are part of the communication network that are willing to participate in job executions. The job workers may include end user devices (e.g., a smartphone, tablet, laptop, etc.) and/or devices that implement the infrastructure of the communication network (e.g., devices that implement RANs or the mobile network core). The computing manager is a network entity that is part of the communication network that accepts requests for jobs to be executed in the communication network from job seekers and manages the execution of those jobs in the communication network. Advantageously, the computing manager may have access to detailed information regarding the communication network and have the ability to control network resource allocation in the communication network, and may leverage such information/capability to optimize job execution in the communication network.

According to some embodiments, job workers provide (or “advertise”) information to the computing manager regarding the resources they are willing to make available for job executions. A job seeker may send a request to the computing manager to execute a job in the communication network. In response to receiving the request from the job seeker, the computing manager may divide the job into job portions and determine an assignment of the job portions to one or more job workers. The computing manager may divide the job and determine the assignment of job portions based on the requirements of the job (e.g., the maximum allowed latency for completing the job as specified by the job seeker), information regarding the resources that job workers are willing to make available for job executions (e.g., which were advertised by the job workers), information regarding the network condition of the mobile network, and information regarding network resources allocated to job workers in the mobile network. The computing manager may determine the assignment of job portions in a manner that optimizes an objective function. The computing manager may change a network resource allocation for some of the one or more job workers to help optimize job execution. Once the computing manager determines the assignment of job portions to the one or more job workers, the computing manager may provide the job portion assignments to the one or more job workers in accordance with the determined assignment. The computing manager may provide the data that the job or job portions are to operate on to the job workers. The job workers may execute the respective job portions they were assigned to generate partial execution results. The job workers may then provide their respective partial execution results to the computing manager. The computing manager may aggregate the partial execution results to generate a full execution result and provide the full execution result to the job seeker.

A technological advantage of embodiments described herein over conventional OTT crowd computing solutions is that the computing manager has detailed information regarding the network condition of the underlying communication network and has the ability to change the network resource allocation for certain job workers. Thus, the computing manager may leverage such information and/or capability when determining how to assign job portions to job workers in a manner that optimizes job execution. For example, the computing manager may allocate additional bandwidth to a subset of job workers offering less computing resources compared to other job workers participating in job execution to help reduce latency. This type of balancing can help avoid a scenario in which certain job workers act as a bottleneck to job execution (e.g., due to having less computing resources and/or less network resources). Such balancing is not possible with conventional OTT crowd computing solutions as they do not have access to detailed information regarding the underlying communication network and do not have control over how network resources are allocated in the underlying communication network.

In one example use case, a network operator of a communication network may use embodiments described herein to provide an additional service that can be monetized. For example, a mobile network operator (MNO) of a mobile network may provide a service that executes jobs in the mobile network on behalf of job seekers. The owners/operators of job seekers may compensate the MNO for executing jobs in the mobile network on behalf of the job seekers. Also, the MNO may compensate the owners/operators of job workers in the mobile network (e.g., user equipment (UE) that connect to the mobile network) for participating in (or offering to participate in) job executions. Embodiments are further described herein below with reference to the accompanying figures.

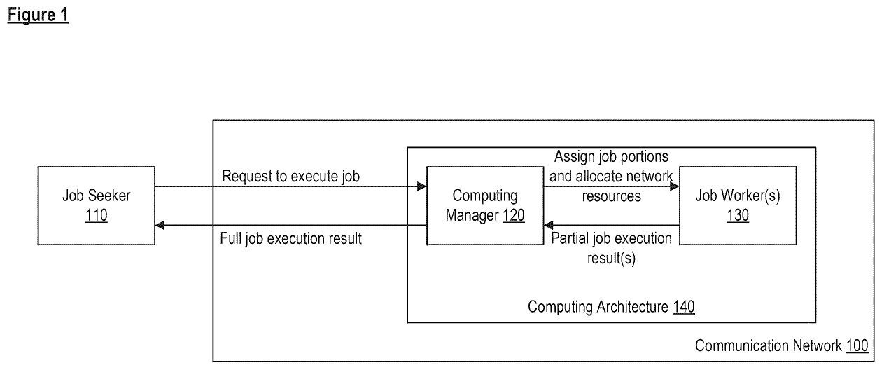

FIG. 1 is a diagram of an environment in which jobs can be executed in a communication network, according to some embodiments. As shown in the diagram, the environment includes a job seeker 110 and a communication network 100. In an embodiment, the communication network 100 is a mobile network (e.g., a Fifth Generation (5G) mobile network or a Fourth Generation (4G) Long Term Evolution (LTE) mobile network). The communication network 100 includes a computing manager 120 and job worker(s) 130. The computing manager 120 and the job worker(s) 130 may be seen as forming a computing architecture 140 that can execute jobs on behalf of job seekers 110. The communication network 100 may include additional network entities that are not shown in the diagram.

The job seeker 110 is a network entity that has a job to be executed. By way of example, the diagram shows the job seeker 110 as being external to the communication network 100. However, it is possible that the job seeker 110 is part of the communication network 100 (e.g., an end user device of the communication network 100). Also, while for sake of illustration the diagram shows a single job seeker 110, it should be understood that there can be more than one job seeker 110. The job seeker 110 may send a request to the computing manager 120 to execute a job in the communication network 100. The job may require a predetermined number of computations (e.g., measured in terms of the number of floating point operations (FLOPs)) that operate on data of a given size (e.g., measured in bytes)). The request may include information regarding the requirements of the job such as the number of computations needed to complete the job, the size of the data that the job is to operate on, and/or the maximum latency to complete job execution. In an embodiment, the owner/operator of the job seeker 110 compensates the owner/operator of the communication network (the network operator) for executing jobs submitted by the job seeker 110 (e.g., in accordance with a formalized agreement established between the owner/operator of the job seeker 110 and the network operator).

The job workers 130 are network entities that are part of the communication network that are willing to participate in job executions on behalf of job seekers 110. The job workers 130 may include end user devices of the communication network 100 (e.g., a smartphone, tablet, laptop, etc.) and/or devices that implement the infrastructure of the communication network 100 (e.g., devices that implement RANs, mobile network core, etc.). The job workers 130 may provide information to the computing manager 120 regarding the resources (e.g., computing resources, memory resources, storage resources, etc.) they are willing to make available for job executions (this may be referred to as an advertisement). For example, a job worker 130 may provide information to the computing manager 120 that the job worker 130 is willing to make one TFLOPS (teraflops per second) of computing resources, 1 GB (gigabyte) of memory resources, and 1 GB of storage resources available for the next hour for job executions. In an embodiment, the network operator compensates the owners/operators of the job workers 130 for willing to participate in job executions and/or actually participating in job executions, for example, in the form of monetary compensation (e.g., a discount on an upcoming bill that is due and/or exclusive/better use of the communication network 100 (e.g., higher peak throughput and/or better coverage)) or other type of reward that incentivizes participation in job executions. In general, any computing device that is part of the communication network and has resources that can be made available for job executions may function as a job worker 130.

The computing manager 120 is a network entity that is part of the communication network 100 that manages job executions in the communication network 100. The computing manager 120 may receive a request from a job seeker 110 to execute a job in the communication network 100. In response to receiving the request, the computing manager 120 may divide the job into job portions and determine an assignment of the job portions to job workers 130 that will fulfill the job requirements and minimize an objective function. The objective function may be chosen by the computing manager 120 or by the job seeker 110. In an embodiment, the objective is to minimize the time/latency required to complete job execution or deliver the job execution results to the job seeker 110. The computing manager 120 may decide to assign job portions to all of the job workers 130 or just a subset of the job workers 130. In an embodiment, the computing manager 120 determines the assignment of job portions to job workers 130 based on a) the job characteristics/requirements (e.g., the amount of computing resources needed to complete the job and the maximum allowed latency to complete job execution); b) information regarding the resources (e.g., computing resources, memory resources, storage resources, etc.) that job workers 130 are willing to make available for job executions (e.g., which was advertised by the job workers 130); c) information regarding the network condition of the communication network 100 (e.g., current network condition and/or predicted future network condition); and d) information regarding network resources allocated to job workers 130. The computing manager 120 may also change the network resource allocation for one or more of the job workers 130 to help optimize job execution. Once the computing manager 120 determines how to assign the job portions to job workers 130, the computing manager 120 may provide job portion assignments to the job workers 130 in accordance with the determined assignment.

It should be noted that the computing manager 120 may be a network entity in the communication network that has detailed information regarding the network condition of the communication network and that has the ability to change network resource allocation within the communication network. The computing manager 120 may leverage this information and/or capability to optimize job execution. For example, the computing manager 120 may estimate the network capacity that each job worker 130 could achieve if assigned additional unused network resources of the communication network (e.g., radio resources and/or non-radio resources). The maximum network capacity for a job worker 130 may depend on both the propagation conditions experienced by the job worker 130 and the instantaneous network traffic (congestion) in the area where the job worker 130 is located. The level of congestion in the area determines the available network resources (e.g., bandwidth) that can be allocated to the job worker 130 in addition to the network resources currently allocated to the job worker 130. The computing manager 120 may leverage information about the congestion level in different areas of the communication network 100 at any given time to estimate the network capacity that could be achieved by each job worker 130 if allocated additional unused network resources. It should be noted that such network resources would remain unused if not allocated to job workers 130. Thus, their allocation to job workers 130 may not negatively affect end user devices of the communication network 100 that do not participate in job executions. In general, a job worker 130 in a non-congested area may be allocated more network resources compared to a job worker 130 in a congested area, thereby potentially achieving a higher maximum network capacity than the latter. It should be noted that conventional OTT crowd computing solutions do not have detailed visibility into the network condition of the underlying communication network 100 and do not have the capability to control network resource allocation in the communication network 100. Thus, they are not able to leverage such information and capability to optimize job execution.

An example flow of operations for executing a job in the communication network will now be described with reference to the diagram to illustrate an embodiment. The flow may begin with the job seeker 110 sending a request to the computing manager 120 to execute a job in the communication network 100 (shown as “Request to execute job” in the diagram). The request may include information regarding the computing resources needed to execute the job, information regarding the amount of storage resources needed to execute the job, and information regarding the desired/maximum latency to complete execution of the job. In an embodiment, the computing manager 120 sends an acknowledge message to the job seeker 110 to indicate that the request has been received.

Each of the job workers 130 may provide information to the computing manager 120 regarding the resources that the job worker 130 is willing to make available for job executions (not shown in the diagram). The information provided by a job worker 130 may include information regarding the amount of computing resources (e.g., central processing unit (CPU)) that the job worker 130 is willing to make available for job executions, information regarding the amount of storage resources (e.g., non-volatile memory) that the job worker 130 is willing to make available for job executions, information regarding the amount of memory resources (e.g., volatile memory such as random access memory (RAM)) that the job worker 130 is willing to make available for job executions, information regarding the amount of energy (e.g., battery life) that the job worker 130 is willing to expend for job executions, and/or information regarding the times during which the job worker 130 is willing to participate in job executions. In an embodiment, the information regarding the resources that the job worker 130 is willing to make available for job executions includes information indicating that the job worker 130 has specialized hardware (e.g., fast Fourier transform (FFT) accelerators) that can be used for job executions. The use of specialized hardware may be particularly beneficial for video/image processing jobs/applications. In an embodiment, information regarding the resources that a job worker 130 is willing to make available for job executions is provided over the control plane of the communication network 100 and thus does not count towards the job worker's data quota, if any.

The computing manager 120 may keep track of the resources that the job workers 130 are willing to make available for job executions. Also, the computing manager 120 may keep track of the network condition of the communication network 100 and the network resources allocated to the job workers 130 in the communication network 100. In an embodiment, the network condition of the communication network 100 includes the current network condition of the communication network 100 and/or a prediction of the future network condition of the communication network 100 (e.g., what the level of congestion will be in different areas of the communication network 100 at the time when the job will be executed and where job workers 130 will be located at that time).

The computing manager 120 may determine an assignment of job portions to one or more of the job workers 130 based on the requirements of the job, information regarding the resources that job workers are willing to make available for job executions, information regarding the network condition of the communication network 100, and information regarding network resources allocated to job workers 130 in the communication network 100. In an embodiment, the computing manager 120 determines the assignment of job portions to job workers 130 based on executing a job assignment algorithm (e.g., a linear programming algorithm that optimizes an objective function, as describe in further detail herein below). In an embodiment, the computing manager 120 over-allocates resources to a job to take into account the possibility of losing connections with job workers 130. For example, if one of the job workers 130 is a mobile device that has an unstable connection, the computing manager 120 may take into account the probability that the job worker 130 may not be reachable in the future when determining how much resources to allocate for the job and/or determining how to assign job portions to job workers 130.

In an embodiment, the computing manager 120 changes the network resource allocation for one or more of the job workers 130 to optimize job execution (the ability to change the network resource allocation for one or more of the job workers 130 may have been taken into consideration when determining how to assign job portions to the job workers 130). In an embodiment where the communication network 100 is a mobile network (e.g., a 4G LTE mobile network, 5G mobile network, or other type of radio/cellular network), the computing manager 120 may change the network resource allocation for a job worker 130 by changing the radio resource allocation for the job worker 130. This may include changing the radio bandwidth for the job worker 130, changing the radio transmission power for the job worker 130, changing the beamforming setting for the job worker 130, and/or changing the modulation coding scheme (MCS) setting for the job worker 130. Alternatively or additionally, in an embodiment, the computing manager 120 changes the non-radio resource allocation for a job worker 130. This may include, for example, changing the priority assigned to network traffic associated with the job worker 130 (e.g., in the mobile network core (e.g., 5G core)).

If the computing manager 120 determines that the job can be executed within the constraints specified by the job seeker 110, the computing manager 120 may provide the job portion assignments to the one or more job workers 130 according to the determined assignment (the change in network resource allocation and the providing of the job portion assignment is shown as “Assign job portions and allocate network resources” in the diagram). The job portion assignment provided to a job worker 130 may include information regarding the particular portion of the job that the job worker 130 is responsible for executing. This may include information regarding the amount of resources that are needed to execute the job portion. In an embodiment, a job worker 130 that receives a job portion assignment from the computing manager 120 provides an acknowledge message to the computing manager 120 indicating whether the job worker 130 accepts or rejects the job portion assignment. In an embodiment, the acknowledgement message is provided over the control plane of the communication network 100 and thus does not count towards the job worker's data quota, if any.

In an embodiment, the job seeker 110 provides the data that the job is to operate on (or information regarding where to obtain such data) to the computing manager 120. The computing manager 120 may provide an acknowledgement message to the job seeker 110 to indicate that the data has been successfully received or not.

Depending on the type of job, the computing manager 120 may provide some or all of the data to the job workers 130. The data may be provided over multiple steps (e.g., incrementally as additional data is needed). In an embodiment, the transmission of this data does not count towards the job worker's data quota, if any.

The job workers 130 may execute their respective assigned job portions and provide the execution results (partial execution results) to the computing manager 120 (shown as “Partial job execution result(s)” in the diagram). The partial execution results may be provided over multiple steps (e.g., incrementally as results become available). In an embodiment, the transmission of the partial execution result does not count towards the job worker's data quota, if any. In an embodiment, the computing manager 120 sends an acknowledge message to each job worker 130 that provided a partial execution result to indicate that the partial execution result has been received. In an embodiment, the computing manager 120 provides compensation or other type of reward to the owners/operators of the job workers 130 that participated in job execution (or expressed a willingness to participate in job execution) (e.g., by applying a credit to the owner/operator's account).

The computing manager 120 may aggregate the partial execution results it received from the job workers 130 to generate a full execution result. The computing manager 120 may then provide the full execution result (possibly with some post-processing) to the job seeker 110 (shown as “Full job execution result” in the diagram).

There can be two different types of jobs that can be executed in the communication network 100: (1) same-data different-instruction jobs; and (2) different-data same-instruction jobs. Same-data different-instruction job are jobs that perform different operations on the same data and can be parallelized. One example of this type of job is the mining of blocks in a centralized blockchain where different nonce intervals are tried by different users. Different-data same-instruction jobs are jobs where the data is split into data chunks and distributed among different job workers 130, with all job workers 130 performing the same operations on their respective data chunks. One example of this type of job is the distributed learning of weights and biases of a neural network (similar to federated learning except the data is received from the communication network rather than locally observed/gathered by the device).

To help further illustrate embodiments, a mathematical model of a simple scenario that the communication network 100 can face and solve is described below. The mathematical model illustrates that the problem is well-defined and solvable. However, it should be understood that the mathematical is provided merely as an example and that some embodiments may not conform to this particular mathematical model.

For sake of simplicity, it is assumed in this example that there is one job seeker 110 and two job workers 130. The computing manager's 120 role is to assign the job seeker's 110 job to the job workers 130.

Let s be the computational burden (measured in FLOPs) of the job. This is the total number of computations that are needed to execute the job (it should be noted that this is not the number of operations per second, which would be measured in FLOPS rather than FLOPs).

Let d be the size of the data that the job is to operate on (measured in bits). The two job workers 130 are mobile devices of a mobile network. The maximum network capacities of the first job worker and the second job worker are denoted as C₁ and C₂, respectively (measured in bits per second).

Each job worker 130 may provide information to the computing manager 120 regarding the computational power that the job worker 130 is willing to make available for job executions (measured in FLOPS) and the maximum computational burden that the job worker 130 is willing to carry for job executions (measured in FLOPs). These two values determine the number of seconds that the job worker 130 is willing to spend on job executions. Let the computational power of job worker k be Sₖ and the maximum computational burden that the job worker 130 is willing to carry be s_{k,max}.

Each job worker 130 may also provide information to the computing manager 120 regarding the amount of storage resources and memory resources that the job worker 130 is willing to make available for job executions. In this example, it is assumed for the sake of simplicity that there is sufficient storage resources and memory resources to execute the job.

The computing manager 120 may determine whether there are enough computing resources made available by job workers 130 to fulfill the job requirements or not. The following inequality needs to be satisfied for the computing manager 120 to accept the job: s≤s_{1,max}+s_{2,max}.

The computing manager 120 may determine the computational burdens for the first job worker and the second job worker, s₁ and s₂ respectively, based on the type of the job to be executed. If the job is a same-data different-instruction type of job then the size of the data that is provided to the job workers 130 is dₖ=d. If the job is a different-data same-instruction type of job, then the data provided to the job workers 130 is split into two parts having size d₁ and d₂, respectively, such that d₁+d₂=d.

The time it takes job worker k to finish executing its job portion in either case is

$${τ}_{k} = \frac{{d}_{k}}{{C}_{k}} + \frac{{s}_{k}}{{S}_{k}}$$

(where the first term represents the time for the data to arrive and the second term represents the time to execute the job portion). Irrespective of the job type, the following equality needs to hold: s=s₁+s₂. In other words, the total computational burden s needs to be split among the two job workers 130.

The computing manager 120 needs to solve the following problem: min max{τ₁, τ₂}, where the minimum is over all the variables that can be optimized (for the same-data different-instruction type of job the variables may be s₁ and s₂; for the different-data same-instruction type of job the variables may be s₁, s₂, d₁, and d₂). The “min max” problem is a linear programming problem that can be solved with algorithms that are known to those skilled in the programming arts. Linear programming problems are known to be scalable with insignificant computational requirements for the optimizer (the computing manager 120 in this example) with up to hundreds of variables (the number of job workers 130 in this example).

It should be noted that for the sake of simplicity the mathematical model described above does not consider the time it takes to transmit the job execution results on the uplink channel. This may be factored in without changing the overall solution methodology. Also, for the sake of simplicity the mathematical model described above assumes there are only two job workers 130. It should be understood, however, that the mathematical model may be extended/generalized to have more than two job workers 130.

A possibly suboptimal but fast (heuristic) solution to distribute a same-data different-instruction type of job among two job workers 130 is now described. The solution configures the system to receive all partial job execution results at the same. To find such a solution, it is imposed that τ₁=τ₂. That is, it is imposed that

$$\frac{d}{{C}_{1}} + \frac{{s}_{1}}{{S}_{1}} = \frac{d}{{C}_{2}} + \frac{{s}_{2}}{{S}_{2}} .$$

Without loss of generality, if it is assumed that C₁≥C₂ (the first job worker has the same or higher network capacity than the second job worker), then the first term in the following equality is non-negative:

$$\frac{{s}_{1}}{{S}_{1}} - \frac{{s}_{2}}{{S}_{2}} = \frac{d}{{C}_{2}} - \frac{d}{{C}_{1}} {=}^{Δ} c \geq 0.$$

The solution is as follows provided that both terms are positive:

$${s}_{1} = \frac{{S}_{1}}{{S}_{1} + {S}_{2}} ( s + {cS}_{2} ) , {s}_{2} = \frac{{S}_{2}}{{S}_{1} + {S}_{2}} ( s - {cS}_{1} )$$

The above equations can be interpreted as follows. The quantity c represents the time advantage that the first job worker enjoys with respect to the second job worker because the data arrives at the first job worker first. The factors in front of the parentheses represent the relative computational power of each job worker 130 compared to the combined computational power of the job workers 130. The terms in each parenthesis represent the computational burden that a particular job worker 130 is to carry.

It is intuitive that if the data arrives later to the second job worker and the second job worker has less computational power compared to the first worker (S₁>S₂), then the first job worker will be asked to carry more computational burden than the second job worker, which is why the term in parenthesis is a sum of two positive terms, s+cS₂, and vice versa for the second job worker. If the first job worker has much more computational power compared to the second job worker (S₁>>S₂) then the term in parenthesis for the second job worker can become negative, which means that the second job worker will not be asked to carry any computational burden. The solution may thus be given as:

$${s}_{1} = \frac{{S}_{1}}{{S}_{1} + {S}_{2}} ( s + {cS}_{2} ) , {s}_{2} = \frac{{S}_{2}}{{S}_{1} + {S}_{2}} max \{ 0 , s - {cS}_{1} \}$$

It should be noted that the mathematical model described above does not consider the energy impact on the job workers 130. In some embodiments, this could be included as another constraint for assigning job portions to job workers 130 (e.g., a job worker 130 only participates in job execution if it is connected to a power source or has enough battery life remaining).

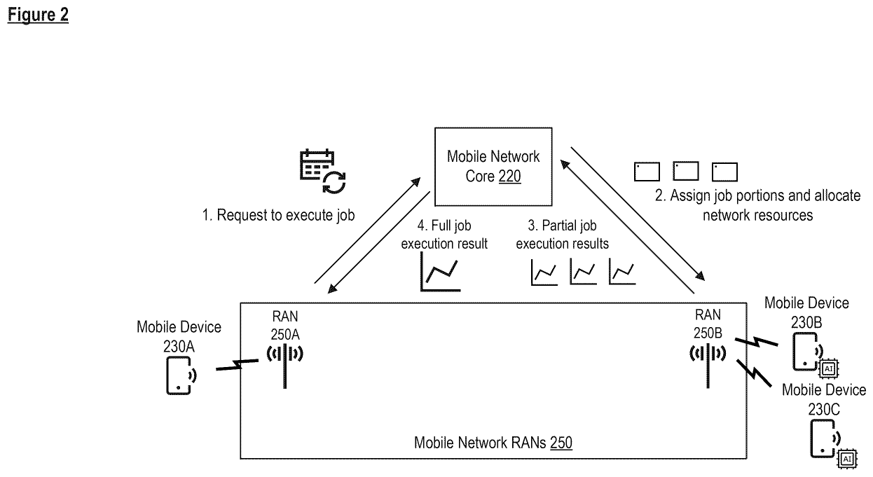

FIG. 2 is a diagram of a mobile network environment in which jobs can be executed, where the job seeker is part of the mobile network, according to some embodiments.

As shown in the diagram, the environment includes mobile devices 230A-C, mobile network RANs 250A and 250B, and a mobile network core 220. In this example, the mobile network core 220 functions as a computing manager. Also, as shown in the diagram, mobile device 230A connects to the mobile network via RAN 250A and mobile device 230B connects to the mobile network via RAN 250B. In this example, mobile device 230A functions as a job seeker, while mobile device 230B and mobile device 230C function as job workers. Mobile device 230B and mobile device 230C may have previously informed the mobile network core 220 of their willingness to participate in job executions.

As shown in the diagram, at operation ‘1’, mobile device 230A sends a request to the mobile network core 220 to execute a job (e.g., an artificial intelligence (“AI”) job). In response to receiving the request, the mobile network core 220 determines an assignment of job portions of the job to mobile devices 230B and 230C (e.g., as described above). At operation ‘2’, the mobile network core 220 provides job portion assignments to mobile device 230B and mobile device 230C in accordance with the determined assignment and changes a network resource allocation for mobile device 230B and/or mobile device 230C. Mobile device 230B and mobile device 230C execute their respective assigned job portions to each generate a partial job execution result. At operation ‘3’, mobile device 230B and mobile device 230C each provide their respective partial job execution results to the mobile network core 220. The mobile network core 220 aggregates the partial job execution results to generate the full job execution result. At operation ‘4’, the mobile network core 220 provides the full job execution result to mobile device 230A.

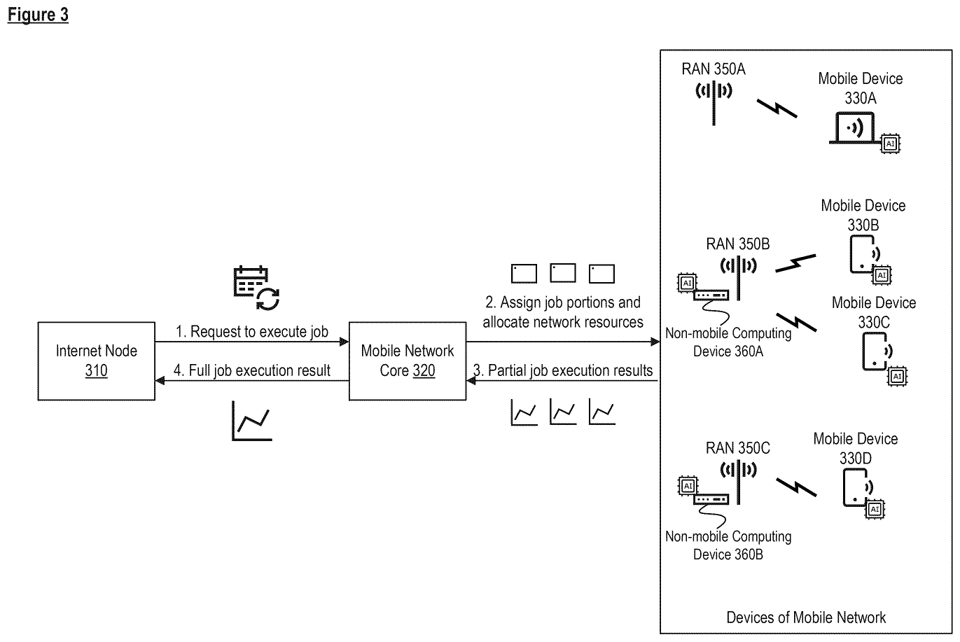

FIG. 3 is a diagram of a mobile network environment in which jobs can be executed, where the job seeker is external to the mobile network and where both mobile devices and non-mobile devices in the mobile network participate in job execution, according to some embodiments.

As shown in the diagram, the environment includes an internet node 310, a mobile network core 320, mobile network RANs 350A-C, non-mobile computing devices 360A and 360B, and mobile devices 330A-D. In the example shown in the diagram, the internet node 310 is external to the mobile network and functions as a job seeker 110. Also, in this example, the mobile network core 220 functions as a computing manager. As shown in the diagram, mobile device 330A connects to the mobile network via RAN 350A, mobile device 330B and mobile device 330C connect to the mobile network via RAN 350B, and mobile device 330D connects to the mobile network via RAN 350C. In this example, non-mobile computing device 360A is located near RAN 350B and non-mobile computing device 360B is located near RAN 350C. Also, in this example, mobile devices 230A-C and non-mobile computing devices 360A and 360B function as job workers. These devices may have previously informed the mobile network core 320 of their willingness to participate in job executions.

As shown in the diagram, at operation ‘1’, the internet node 310 sends a request to the mobile network core 320 to execute a job (e.g., an AI job). In response to receiving the request, the mobile network core 320 determines an assignment of job portions of the job to mobile devices 230A-D and non-mobile computing devices 360A and 360B (e.g., as described above). At operation ‘2’, the mobile network core 320 provides job portion assignments to mobile devices 230A-D and non-mobile computing devices 360A and 360B in accordance with the determined assignment and changes a network resource allocation for some or all of these devices. Mobile devices 230A-D and non-mobile computing devices 360A and 360B execute their respective assigned job portions to each generate a partial job execution result. At operation ‘3’, mobile devices 230A-D and non-mobile computing devices 360A and 360B each provide their respective partial job execution results to the mobile network core 320. The mobile network core 320 aggregates the partial job execution results to generate the full job execution result. At operation ‘4’, the mobile network core 320 sends the full job execution result to the internet node 310.

In one example use case, the mobile network operator may use embodiments disclosed herein to become orchestrators of the computational power that is sitting idle in their end user's pockets and/or in the mobile network infrastructure.

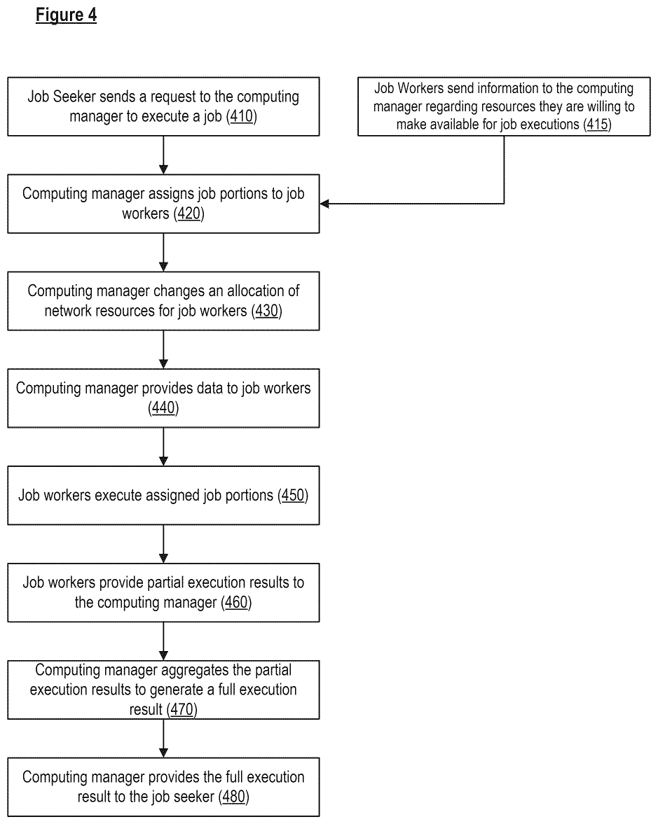

FIG. 4 is a flow diagram of a method for executing a job in a communication network, according to some embodiments. The method may be performed by a system that includes a job seeker, a computing manager, and job workers.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

At operation 410, the job seeker sends a request to the computing manager to execute a job. At operation 415, the job workers send information to the computing manager regarding the resources that they are willing to make available for job executions. Operation 415 may occur prior to, in parallel with, and/or after operation 410. At operation 420, the computing manager assigns job portions to the job workers. At operation 430, the computing manager changes a network resource allocation for job workers. At operation 440, the computing manager provides data that the job is to operate on to the job workers. At operation 450, the job workers execute their respective assigned job portions, which results in generating partial execution results. At operation 460, the job workers provide the partial execution results to the computing manager. At operation 470, the computing manager aggregates the partial job execution results to generate a full execution result. At operation 480, the computing manager provides the full execution result to the job seeker.

FIG. 5 is a flow diagram of a method performed by one or more computing devices implementing a computing manager for executing a job in a mobile network (also referred to as a mobile telecommunications network), according to some embodiments. In an embodiment, the mobile network includes at least one base station (e.g., an eNodeB and/or gNodeB). In an embodiment, the job can be unrelated to providing mobile telecommunications services.

At operation 510, the computing manager receives, from a job seeker, a request to execute a job in the mobile network. In an embodiment, the job seeker is part of the mobile network. In another embodiment, the job seeker is external to the mobile network. In an embodiment, the request to execute the job in the mobile network includes information regarding an amount of computing resources needed to execute the job, information regarding a desired latency to complete execution of the job, and/or information regarding an amount of storage resources needed to execute the job.

At operation 520, the computing manager obtains, for each of a plurality of job workers that are part of the mobile network, information regarding resources that the job worker is willing to make available for job executions. In an embodiment, the information regarding resources that one of the plurality of job workers is willing to make available for job executions includes information regarding an amount of computing resources that the job worker is willing to make available for job executions, information regarding an amount of memory resources that the job worker is willing to make available for job executions, information regarding an amount of storage resources that the job worker is willing to make available for job executions, and/or information regarding times during which the job worker is willing to participate in job execution.

At operation 530, the computing manager determines an assignment of job portions to one or more job workers from the plurality of job workers based on requirements of the job, the information regarding resources that the plurality of job workers are willing to make available for job executions, information regarding a network condition of the mobile network, and information regarding network resources allocated to job workers. In an embodiment, the assignment of job portions to the one or more job workers is determined based on optimizing an objective function. In an embodiment, the one or more job workers includes a mobile device. In an embodiment, the one or more job workers further includes a non-mobile computing device. In an embodiment, the information regarding the network condition of the mobile network includes information regarding a current network condition of the mobile network and information regarding a predicted future network condition of the mobile network.

At operation 540, the computing manager changes a network resource allocation for at least one of the one or more job workers. In an embodiment, changing the network resource allocation for the at least one job worker includes changing a radio resource allocation for a job worker. In an embodiment, changing the radio resource allocation for the job worker includes changing a radio bandwidth for the job worker, changing a radio transmission power for the job worker, changing a beamforming setting for the job worker, and/or changing a MCS setting for the job worker. In an embodiment, changing the network resource allocation for the at least one job worker includes changing a non-radio resource allocation for a job worker. In an embodiment, changing the non-radio resource allocation for the job worker includes changing a priority assigned to network traffic associated with the job worker.

At operation 550, the computing manager provides job portion assignments to the one or more job workers (e.g., indicating which portion of the job the job worker is responsible for executing) in accordance with the determined assignment.

In an embodiment, at operation 560, the computing manager provides data to the one or more job workers (data that the job or job portion is to operate on).

At operation 570, the computing manager receives partial execution results generated by the one or more job workers.

At operation 580, the computing manager aggregates the partial execution results to generate a full execution result.

At operation 590, the computing manager provides the full execution result to the job seeker.

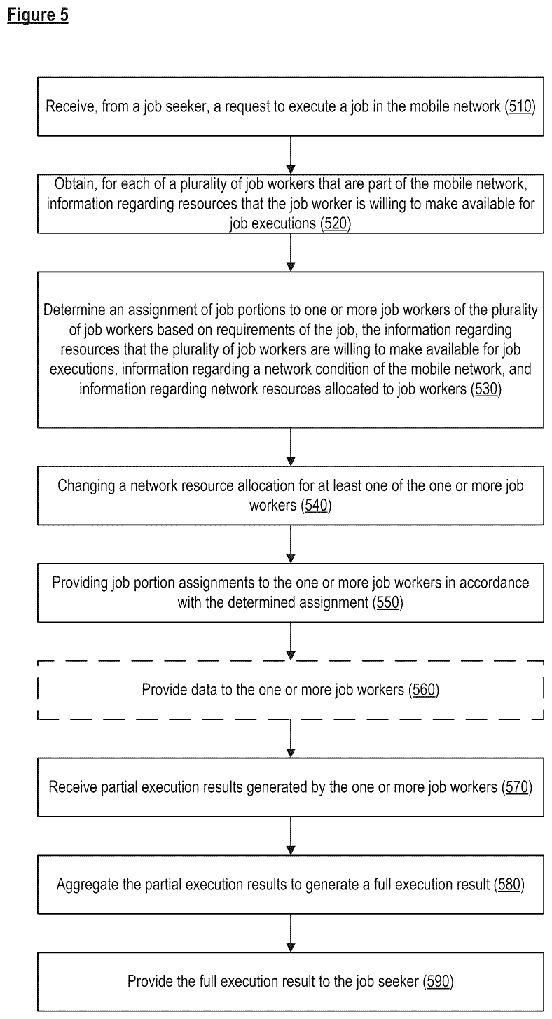

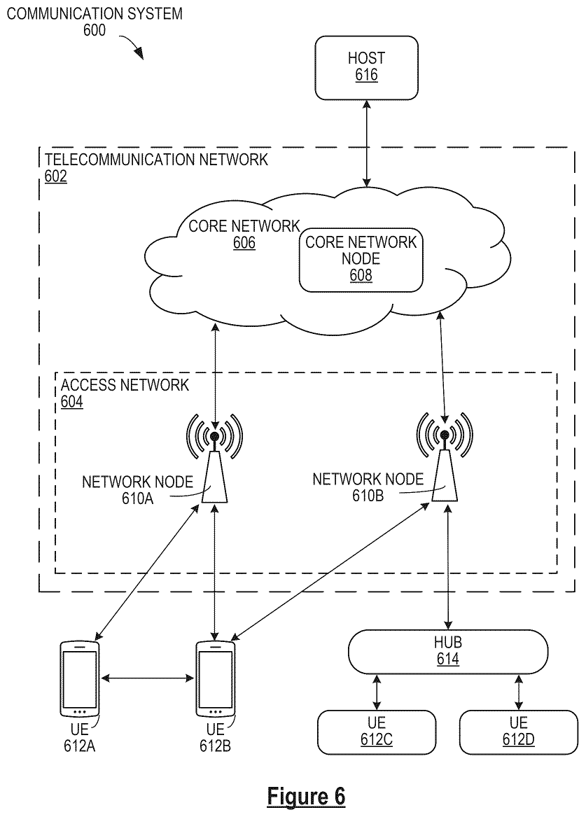

FIG. 6 shows an example of a communication system, according to some embodiments. In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

In an embodiment, the telecommunication network 602 can be used to execute jobs on behalf of job seekers. For example, the host 616 or UEs 612 may function as job seekers, the core network node 608 may function as a computing manager, and the network nodes 610 and/or the UEs 612 may function as job workers, as described herein above. In an embodiment, the same UE 612 functions as a job seeker in some scenarios and act as a job worker in other scenarios.

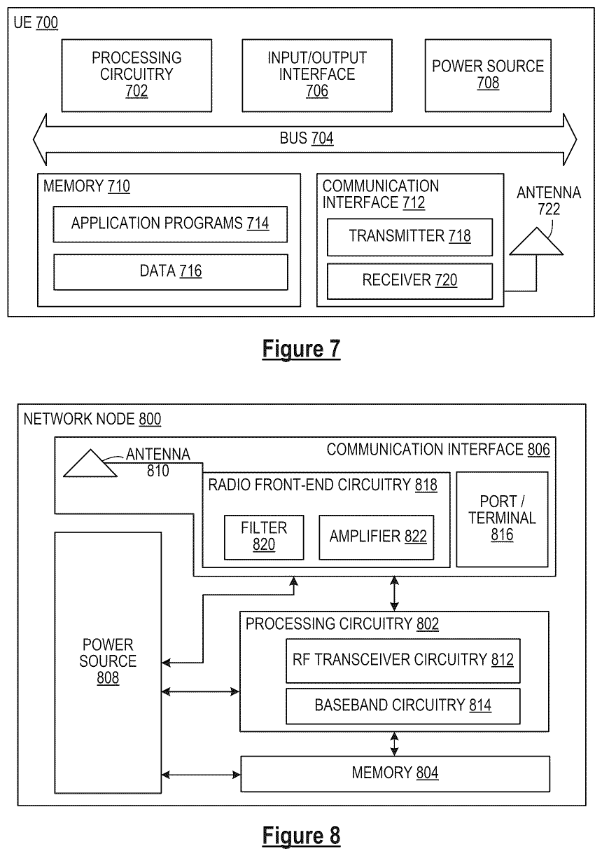

FIG. 7 shows a UE in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In an embodiment, the UE 700 functions as a job seeker and/or a job worker, as described herein above.

FIG. 8 shows a network node, according to some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

In an embodiment, the network node 800 functions as a job worker, as described herein above.

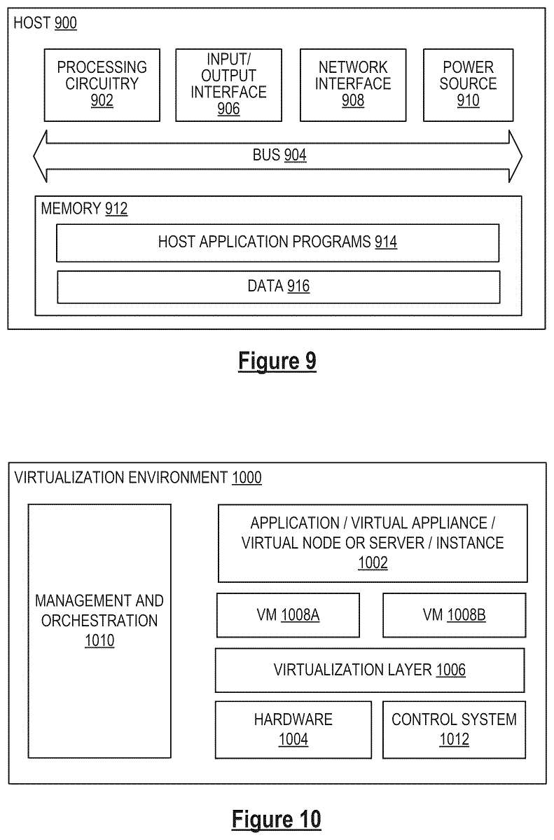

FIG. 9 is a block diagram of a host, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In an embodiment, the host 900 functions as a job seeker, as described herein above.

FIG. 10 is a block diagram illustrating a virtualization environment in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g., such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by one or more computing devices in a mobile telecommunications network including at least one base station, the method comprising:
receiving, from a job seeker, a request to execute a job in the mobile telecommunications network, the job being unrelated to providing mobile telecommunications services;
obtaining, for each of a plurality of job workers that are part of the mobile telecommunications network, information regarding resources that the job worker is willing to make available for job executions;
determining an assignment of job portions to one or more job workers of the plurality of job workers based on requirements of the job, the information regarding resources that the plurality of job workers are willing to make available for job executions, information regarding a network condition of the mobile telecommunications network, and information regarding network resources allocated to job workers in the mobile network;
providing job portion assignments to the one or more job workers in accordance with the determined assignment;
receiving partial job execution results generated by the one or more job workers;
aggregating the partial job execution results to generate a full job execution result; and
providing the full job execution result to the job seeker.

2. The method of claim 1, further comprising
changing a network resource allocation for at least one job worker of the one or more job workers.

3. (canceled)

4. The method of claim 1, wherein the one or more job workers includes a mobile device.

5. The method of claim 4, wherein the one or more job workers further includes a non-mobile computing device.

6. The method of claim 1, wherein the job seeker is part of the mobile network.

7. The method of claim 1, wherein the job seeker is external to the mobile network.

8. The method of claim 1, wherein the request to execute the job in the mobile network includes one or more of: information regarding an amount of computing resources needed to execute the job, information regarding a desired latency to complete execution of the job, and information regarding an amount of storage resources needed to execute the job.

9. The method of claim 1, wherein the information regarding resources that one of the plurality of job workers is willing to make available for job executions includes one or more of: information regarding an amount of computing resources that the job worker is willing to make available for job executions, information regarding an amount of memory resources that the job worker is willing to make available for job executions, information regarding an amount of storage resources that the job worker is willing to make available for job executions, and information regarding times during which the job worker is willing to participate in job execution.

10. The method of claim 1, wherein the information regarding the network condition of the mobile network includes information regarding a current network condition of the mobile network and information regarding a predicted future network condition of the mobile network.

11. The method of claim 1, further comprising:
providing data that the job is to operate on to the one or more job workers.

12. The method of claim 2, wherein the changing the network resource allocation for the at least one job worker includes changing a radio resource allocation for a job worker.

13. The method of claim 12, wherein the changing the radio resource allocation for the job worker includes one or more of: changing a radio bandwidth for the job worker, changing a radio transmission power for the job worker, changing a beamforming setting for the job worker, and changing a modulation coding scheme (MCS) setting for the job worker.

14. The method of claim 2, wherein the changing the network resource allocation for the at least one job worker includes changing a non-radio resource allocation for a job worker.

15. The method of claim 14, wherein the changing the non-radio resource allocation for the job worker includes changing a priority assigned to network traffic associated with the job worker.

16. The method of claim 1, wherein the assignment of job portions to the one or more job workers is determined based on optimizing an objective function.

17. A non-transitory machine-readable storage medium that provides instructions that, if executed by one or more processors of one or more computing devices in a mobile network, causes the one or more computing devices to carry out operations comprising:
receiving, from a job seeker, a request to execute a job in the mobile network;
obtaining, for each of a plurality of job workers that are part of the mobile network, information regarding resources that the job worker is willing to make available for job executions;
determining an assignment of job portions to one or more job workers of the plurality of job workers based on requirements of the job, the information regarding resources that the plurality of job workers are willing to make available for job executions, information regarding a network condition of the mobile network, and information regarding network resources allocated to job workers in the mobile network;
changing a network resource allocation for at least one of the one or more job workers;
providing job portion assignments to the one or more job workers in accordance with the determined assignment;
receiving partial job execution results generated by the one or more job workers;
aggregating the partial job execution results to generate a full job execution result; and
providing the full job execution result to the job seeker.

18. The non-transitory machine-readable storage medium of claim 17, wherein the one or more job workers includes a mobile device.

19. The non-transitory machine-readable storage medium of claim 18, wherein the one or more job workers further includes a non-mobile computing device.

20. The non-transitory machine-readable storage medium of claim 17, wherein the job is unrelated to providing mobile telecommunications services.

21. The non-transitory machine-readable medium of claim 17, the operations further comprising changing, for at least one job worker of the one or more job workers, at least one of: a radio bandwidth, a radio transmission power, a beamforming setting, or a modulation coding scheme (MCS) setting.
